(19) United States
(12) Patent Application Publication
(10) Pub. No.: US 2019/0232598 A1
(43) Pub. Date: Aug. 1, 2019

(54) BUCKLING-INDUCED KIRIGAMI

(71) Applicant: President and Fellows of Harvard College, Cambridge, MA (US)

(72) Inventors: Ahmad Rafsanjani Abbasi, Somerville, MA (US); Katia Bertoldi, Somerville, MA (US)

(21) Appl. No.: 16/261,343

(22) Filed: Jan. 29, 2019

Related U.S. Application Data
(60) Provisional application No. 62/624,371, filed on Jan. 31, 2018.

(51) Int. Cl. B31D 5/04

(52) U.S. Cl. CPC B31D 5/04

(57) ABSTRACT

A kirigami structure including a thin flat sheet and a square-shaped array of perforations cut in the sheet. The array includes alternating rows and columns of adjacent orthogonal perforations interconnected via respective ligaments. The array forms a two-dimensional planar surface in a load-free state, and a three-dimensional kirigami surface in a tensile-load state in which a tensile load applied to the sheet causes out-of-plane buckling of the ligaments.

### CROSS-REFERENCE TO RELATED APPLICATIONS

This application claims priority to and the benefit of U.S. Provisional Patent Application Ser. No. 62/624,371, filed Jan. 31, 2018, and titled “Buckling-Induced Kirigami,” which is incorporated herein by reference in its entirety.

### FIELD OF THE INVENTION

The present invention relates generally to transformation of a two-dimensional sheet into a three-dimensional patterned, perforated surface, and, more specifically, to a kirigami structure induced by buckling of interconnecting ligaments.

### BACKGROUND OF THE INVENTION

In recent years, origami and kirigami have become emergent tools to design programmable and reconfigurable mechanical metamaterials. Origami-inspired metamaterials are created by folding thin sheets along predefined creases, whereas kirigami allows a practitioner to exploit cuts in addition to folds to achieve large deformations and create three-dimensional (“3D”) objects from a flat sheet. Therefore, kirigami principles have been exploited to design highly stretchable devices and morphable structures.

Interestingly, studies show that pre-creased folds are not necessary to form complex 3D patterns, as mechanical instabilities in flat sheets with an embedded array of cuts can result in out-of-plane deformation. However, while a wide range of 3D architectures have been realized by triggering buckling under compressive stresses, instability-induced kirigami designs subjected to tensile loading are limited to a single incision pattern having parallel cuts in a centered rectangular arrangement.

The present disclosure is directed to providing a kirigami structure that solves the above problems and other needs.

### SUMMARY OF THE INVENTION

According to one aspect of the present disclosure, a kirigami structure includes a thin flat sheet and a square-shaped array of perforations cut in the sheet. The array includes alternating rows and columns of adjacent orthogonal perforations interconnected via respective ligaments. The array forms a two-dimensional planar surface in a load-free state, and a three-dimensional kirigami surface in a tensile-load state in which a tensile load applied to the sheet causes out-of-plane buckling of the ligaments.

According to another aspect of the present disclosure, a kirigami structure includes a thin flat sheet having a square shape defined by sheet edges having a length 2L and a thickness t. The sheet has a flat configuration in a load-free state in which the sheet is laterally folded. The kirigami structure further includes a square-shaped array of perforations cut in the sheet, the array including alternating rows and columns of adjacent orthogonal perforations interconnected via respective ligaments. The array forms an identical square unit of the sheet having a length l along each unit edge, the unit further including a hinge with a width δ along each unit edge. Each of the arrays further forms a two-dimensional planar surface in the load-free state in which each of the perforations is closed, and a three-dimensional kirigami surface in a tensile-load state in which a tensile load applied to the sheet causes out-of-plane buckling of the ligaments. Each of the perforations is open in the tensile-load state.

According to yet another aspect of the present disclosure, a method is directed to transforming a sheet into a kirigami structure. The method includes forming a square-shaped array of perforations that are cut into a thin flat sheet, the array including alternating rows and columns of adjacent orthogonal perforations interconnected via respective ligaments. The method further includes, in response to applying a tensile load to the sheet, causing out-of-plane buckling of the ligaments to change the array from a two-dimensional planar surface to a three-dimensional kirigami surface.

Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1A is a perspective schematic of a kirigami system in a load-free state.

FIG. 1B is a top view illustration of a perforated sheet of the kirigami system of FIG. 1A, showing the sheet deforming in-plane in two-dimensions.

FIG. 2A is a perspective schematic of a kirigami system under diagonal tension.

FIG. 2B is a top view illustration of the kirigami system of FIG. 2A, showing a three-dimensional pattern.

FIG. 2C is a perspective illustration of the kirigami system of FIG. 2A in a stretched state.

FIG. 3A is a perspective schematic of a kirigami system under perpendicular tension.

FIG. 3B is a top view illustration of the kirigami system of FIG. 3A, showing a three-dimensional pattern.

FIG. 3C is a perspective illustration of the kirigami system of FIG. 3A in a stretched state.

FIG. 4A illustrates experimental results for a thin sheet with δ/L=0.06 and T/δ=0.085 when the strain εₓ is 0.

FIG. 4B illustrates experimental results for the thin sheet of FIG. 4A when the strain εₓ is 0.12.

FIG. 4C illustrates experimental results for the thin sheet of FIG. 4A when the strain εₓ is 0.24.

FIG. 5 illustrates the bending rigidity of a buckling-induced (Miura-like) kirigami sheet.

FIG. 6A illustrates a buckling-induced (cubic-patterned) kirigami sheet in a flat-folded state.

FIG. 6B illustrates a buckling-induced (Miura-like) kirigami sheet in a flat-folded state.

FIG. 7A illustrates a buckling-induced (cubic-patterned) kirigami sheet in a bending state.

FIG. 7B illustrates a buckling-induced (Miura-like) kirigami sheet in a bending state.

FIG. 8A illustrates a buckling-induced (cubic-patterned) kirigami sheet in a twisted state.

FIG. 8B illustrates a buckling-induced (Miura-like) kirigami sheet in a twisted state.

FIG. 9A shows a perspective schematic of a unit cell and points used to generate different cut shapes.

FIG. 9B shows a connected pattern of the unit cell and points illustrated in FIG. 9A.

FIG. 10A is a schematic illustrating a variant of linear cuts in a triangular grid.

FIG. 10B is a schematic illustrating a variant of triangular cuts in a triangular grid.

FIG. 10C is a schematic illustrating a variant of circular cuts in a triangular grid.

FIG. 10D is a schematic illustrating a variant of trapezoidal cuts in a triangular grid.

FIG. 11 is a schematic illustrating a mirrored pattern based on triangular cuts.

FIG. 12A is a schematic illustrating a linear pattern for a kirigami sheet fabricated by laser cutting a polyester plastic sheet.

FIG. 12B is a schematic illustrating a triangular pattern for a kirigami sheet fabricated by laser cutting a polyester plastic sheet.

FIG. 12C is a schematic illustrating a circular pattern for a kirigami sheet fabricated by laser cutting a polyester plastic sheet.

FIG. 12D is a schematic illustrating a trapezoidal pattern for a kirigami sheet fabricated by laser cutting a polyester plastic sheet.

FIG. 12E is a schematic illustrating another pattern for a kirigami sheet fabricated by laser cutting a polyester plastic sheet.

FIG. 13A is a snapshot illustrating a buckling-induced kirigami pattern in which a triangular pattern has no vertical line.

FIG. 13B is a snapshot illustrating a buckling-induced kirigami pattern in which a triangular pattern has vertical lines in alternating columns.

FIG. 13C is a snapshot illustrating a buckling-induced kirigami pattern in which a triangular pattern has vertical lines in all columns.

FIG. 14A is a plot of experimental results showing stress-strain curves for 10 samples of perforated sheets.

FIG. 14B is a schematic illustrating one of the perforated sheets of FIG. 14A in tension.

FIG. 14C shows formulas for determining the stress and the effective in-plane Young's modulus.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.” Where a range of values is disclosed, the respective embodiments include each value between the upper and lower limits of the range.

In general, the present disclosure describes design details of a perforated planar sheet with different array of perforations (or cuts) that, when pulled, transforms into a 3D-patterned surface with tunable shape and mechanical properties. An exemplary distinguishing feature over previous devices is that the design exploits buckling to create reversible 3D-patterned surfaces instead of using folds and creases.

The cuts have a variety of shapes on different types of grids, and are optimized to impart desired shape and mechanical properties to the structure with tunable curvature, Poisson's ratio, stiffness and stretchability without failure. By applying a large extension, the ligaments are plastically deformed to create homogenous permanent folds that transform the flat perforated sheet into a foldable kirigami structure. For certain patterns, the shape of the kirigami structure is controlled by the direction of applied load. Certain kirigami structures are designed in such a way that they pop-up toward only one side of the sheet, thus, making them suitable for attaching and actuating with a deformable substrate. Other developments includes introducing partial cuts to guide the direction of folding. By carefully designing the shape of the cuts, a hierarchical kirigami structures is provided with compatible and uniform deformation. Because the kirigami structure changes the morphology of the surface, it is optionally used to tune the friction, an important property enabling the turning on and off of friction.

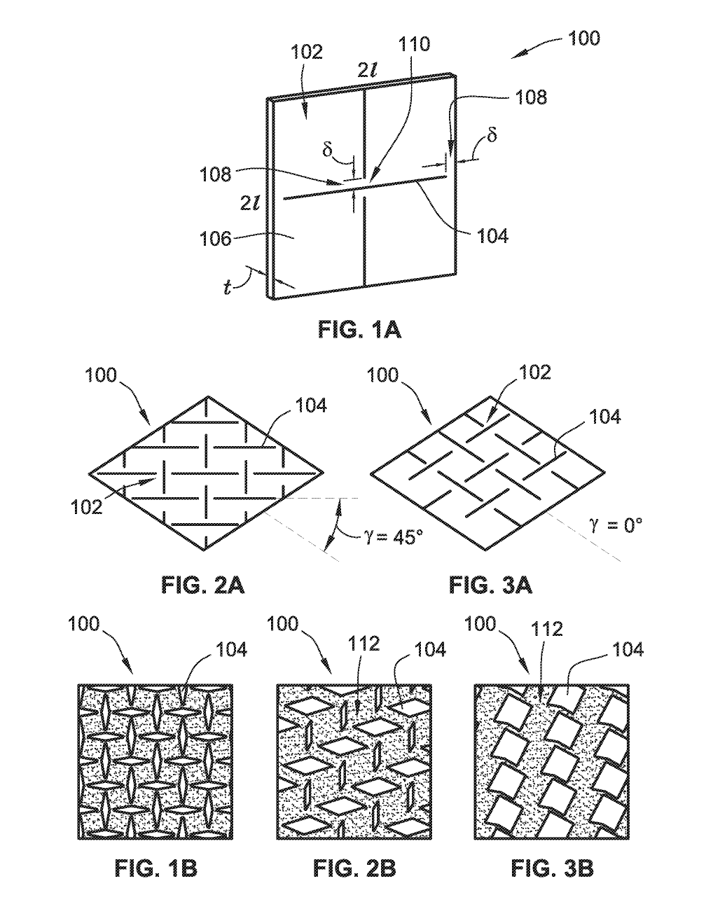

Referring generally to FIGS. 1A-3C, perforating an elastic sheet 100 of thickness t with a square array 102 of mutually orthogonal cuts 104 introduces a network of square domains 106 of edge l. For example, specimens are fabricated by laser cutting an array of 3×8 mutually perpendicular cuts into plastic sheets. The square domains 106 are separated by hinges 108 of width δ. Although the planar response of such perforated sheets 100 in the thick limit (i.e., for large values of t/δ) is characterized by an effective negative Poisson's ratio, sufficiently-thin sheets 100 have mechanical instabilities triggered under uniaxial tension that facilitate the creation of complex 3D patterns. In fact, such mechanical instabilities also guide the formation of permanent plastic folds.

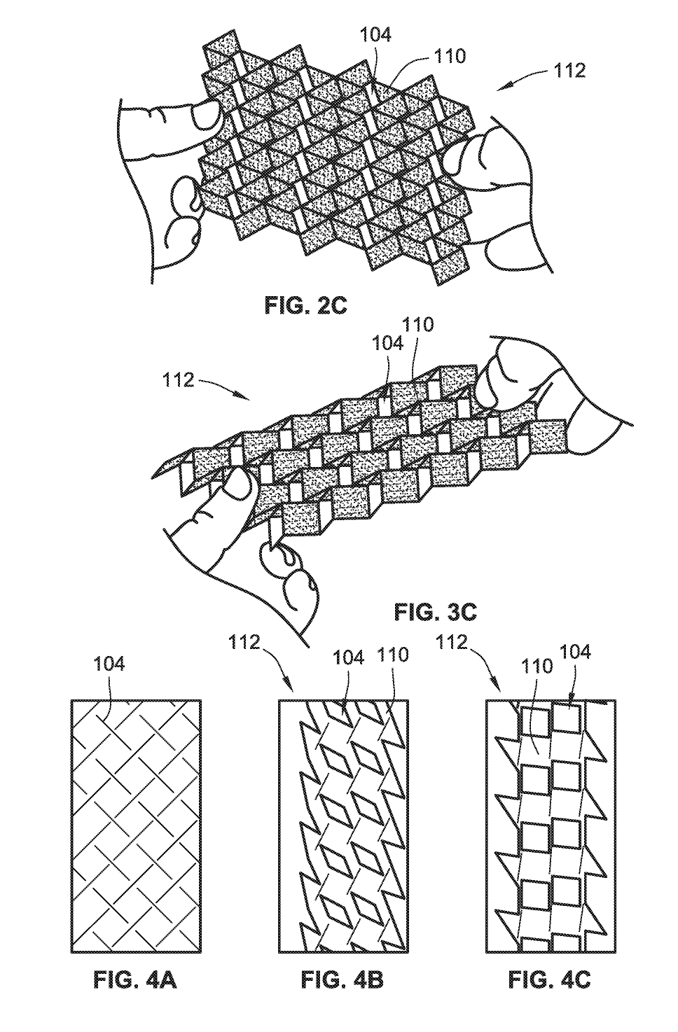

As more specifically illustrated in FIGS. 2A-3C, the morphology of the instability-induced patterns is strongly affected by the loading direction. This points to an effective strategy for realizing functional surfaces characterized by a variety of architecture structures. These architecture structures are referred to as buckling-induced kirigami, which include formed 3D patterns that are achieved by harnessing buckling of ligaments 110 left between neighboring cuts 104. The resulting 3D-patterned surface 112 is akin to kirigami paper-cutting artworks.

The initial response for all samples, as illustrated in FIGS. 1B, 2B, and 3C, is linear. All the hinges 108 bend in-plane, inducing pronounced rotations of the square domains 106, which result in large negative values of the macroscopic Poisson's ratio. As such, the stiffness of the perforated sheets is governed by the in-plane flexural deformation of the hinges and it can be shown that Ē=σₓ/εₓ=⅔E(δ/l)².

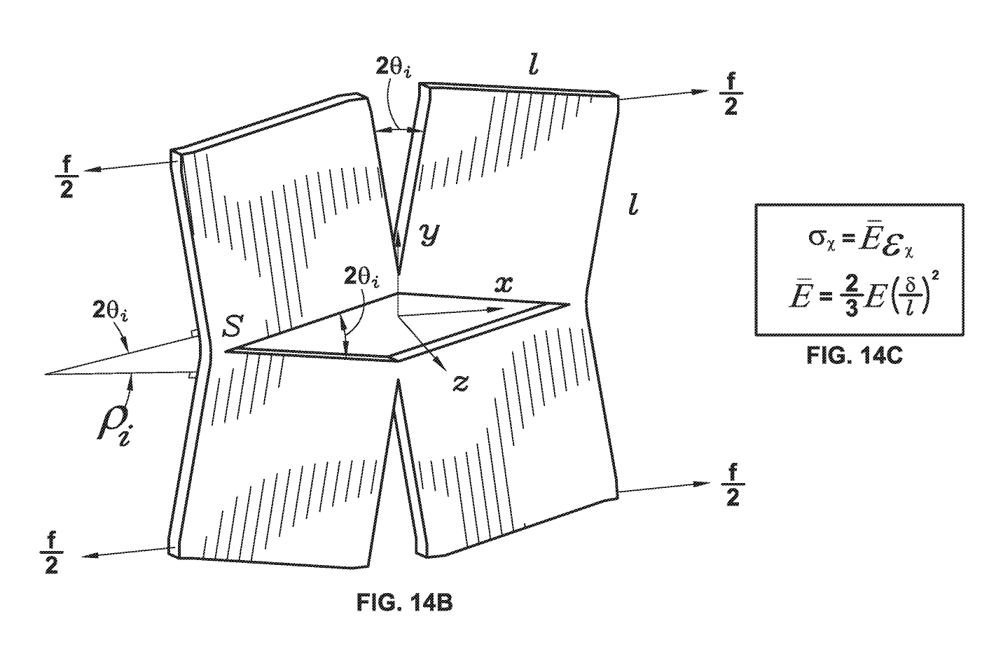

For thin samples, experimental curves (as illustrated in FIG. 14A) show a sudden departure from linearity to a plateaus stress caused by out-of-plane buckling of the hinges 108. Such buckling, in turn, induces out-of-plane rotations of both the square domains 106 and the cuts 104, which arrange to form a 3D pattern reminiscent of a misaligned Miura-ori with an alternation of square solid faces (corresponding to the square domains 106) and rhombic open ones (defined by the cuts 104, e.g., as illustrated in FIGS. 2A and 2B).

For sufficiently large values of the applied strain, the stress rises sharply again. This regime starts when the square domains 106 align (e.g., as illustrated in FIG. 4C) and the deformation mechanism of the hinges 108 switches from bending dominated to stretching dominated. At this state, localized zones of intense strain (of plastic nature) develop in the hinges 108 and result in the formation of permanent folds. Although the starting point is a flat elastic sheet 100 with an embedded array 102 of cuts 104 (i.e., a perforated sheet), by largely stretching the sheet 100 a kirigami structure is achieved that includes a periodic distribution of both cuts and folds.

In contrast to previous Miura-ori, misaligned Miura-ori, and zigzag-base folded kirigami structures, the presently disclosed kirigami structures have a macroscopic Poisson's ratio that is positive. This is the result of the fact that not all the faces are rigid. As such, the applied tensile deformation not only results in the rotation of the faces about the connecting ridges, but also in the deformation of those defined by the cuts, allowing lateral contraction of the kirigami structure. Also, in contrast to previous misaligned Miura-ori that can only be folded to a plane, the additional degree of freedom provided by the open cuts of the presently disclosed kirigami structures allow the present Miura kirigami to be laterally flat foldable.

Referring specifically to FIG. 1A, a general schematic of a kirigami structure shows the elastic sheet 100 of thickness t perforated with the square array 102 of the mutually orthogonal cuts arranged in a square grid. In FIG. 1B, if the thick limit is for large values of t/δ, the perforated sheet 100 deforms in-plane and identically to a network of rotating squares with a negative Poisson's ratio.

However, referring specifically to FIGS. 2A-3C, for sufficiently small values of t/δ mechanical instabilities triggered under uniaxial tension result in the formation of the illustrated complex 3D patterns, which are affected by the loading direction. In FIGS. 2A and 2B, the 3D pattern is obtained for a tensile load applied in a diagonal direction relative to the orientation of the cuts 104, e.g., angle γ is 45°. In FIGS. 3A and 3B, the 3D pattern is obtained for a tensile load applied in a perpendicular or parallel direction to the cuts 104, e.g., angle γ is 0°. The scale bars in FIGS. 2B and 3C are 6=millimeters.

Exemplary benefits of the disclosed kirigami structures are directed to flexibility, stretchability, ease of fabrication, and wide range of tunable mechanical properties. As such, by way of example, unlike intrinsically stretchable materials like rubbers, the disclosed kirigami structures allow large deformation by tuning the geometry of cuts rather than the chemical composition of a base material. Consequently, among other devices, the kirigami structures are useful in smart wearable devices, flexible wearable devices, stretchable electronics, stretchable batteries, stretchable screens, solar panels, sportswear, sport gears, apparel and smart textiles (e.g., self-cooling textiles), medical devices (e.g., wound patches, knee and elbow braces), filters and permeable surfaces, fog collectors, tunable frictional surfaces, flexible connections and hinges, and soft robots. The disclosed buckling-induced strategy provides a simple route for manufacturing kirigami sheets.

Optionally the buckling-induced manufacturing is combined with optimization techniques for designing perforated patterns that are capable of generating desired complex 3D surfaces under external loading. Because the response of the disclosed perforated sheets is essentially scale-free, the disclosed pop-up strategy is useful to fabricate kirigami sheets over a wide range of scales. For example, the scales range from transformable meter-scale architectures to tunable nanoscale surfaces.

Referring to FIGS. 4A-4C, experimental results show the out-of-plane deformation for the thin sheet 100 in which the thickness t<<δ (i.e., for values of thickness t that are much less than the width δ). Specifically, the snapshots refer to a sample with δ/l=0.06 and t/δ=0.085. In FIG. 4A the strain εₓ is 0, in FIG. 4B the strain εₓ is 0.12, and in FIG. 4C the strain εₓ is 0.24.

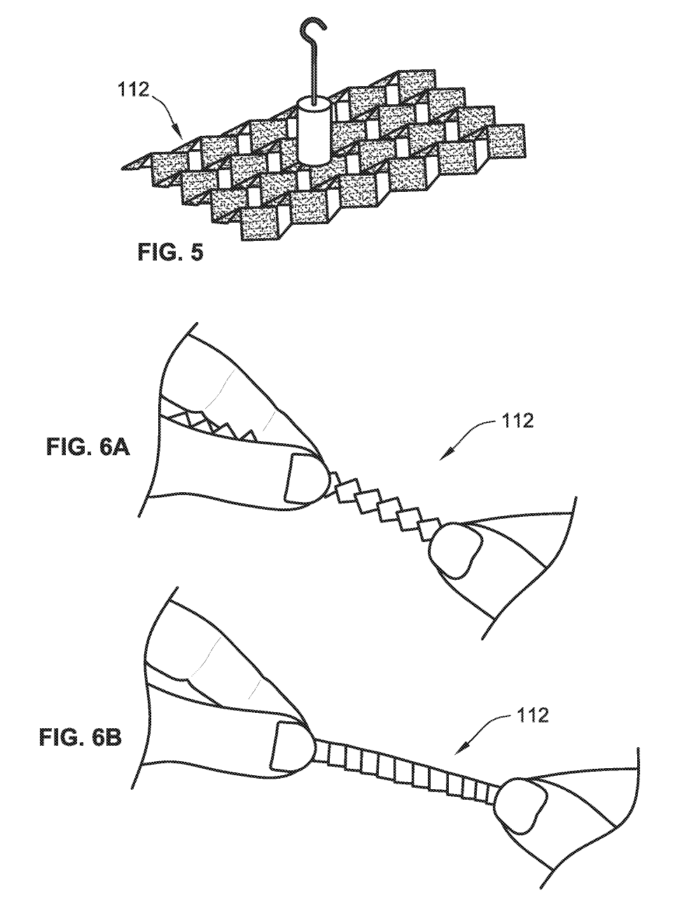

Referring generally to FIGS. 5-8B, exemplary kirigami structures 100 exhibit different mechanical behavior under different loading directions. In particular, cuts 104 take on a variety of shapes on different types of grids. The cuts 104 are optimized to impart desired mechanical properties to the kirigami structures 100, including, for example, curvature, Poisson's ratio, and stiffness.

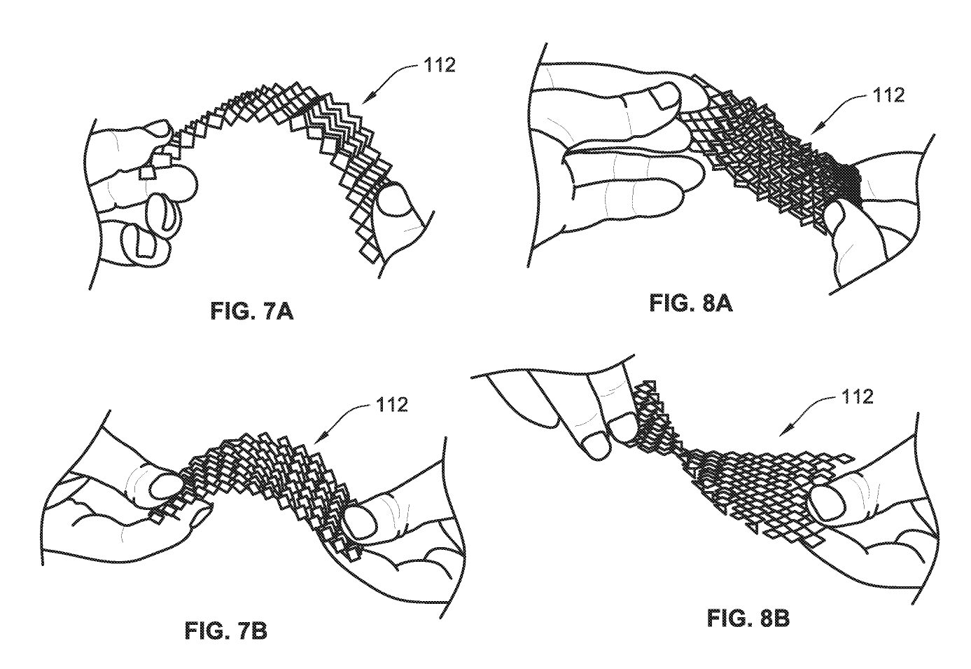

For example, in FIG. 5 the buckling-induced (Miura-like) kirigami structure 100 has a much higher bending rigidity than a corresponding flat perforated sheet. In this example, the kirigami structure 100 has a thickness t of 127 microns (μm) and supports a weight of 20 grams. In other examples, FIG. 6A (cubic-patterned) and FIG. 6B (Miura-like) show the kirigami structure 100 being a flat-foldable structure, FIG. 7A (cubic-patterned) and FIG. 7B (Miura-like) show the kirigami structure 100 forming a saddle shape with a negative Gaussian curvature upon nonplanar bending, and FIG. 8A (cubic-patterned) and FIG. 8B (Miura-like) show the kirigami structure 100 twisting under antisymmetric out-of-plane deformation.

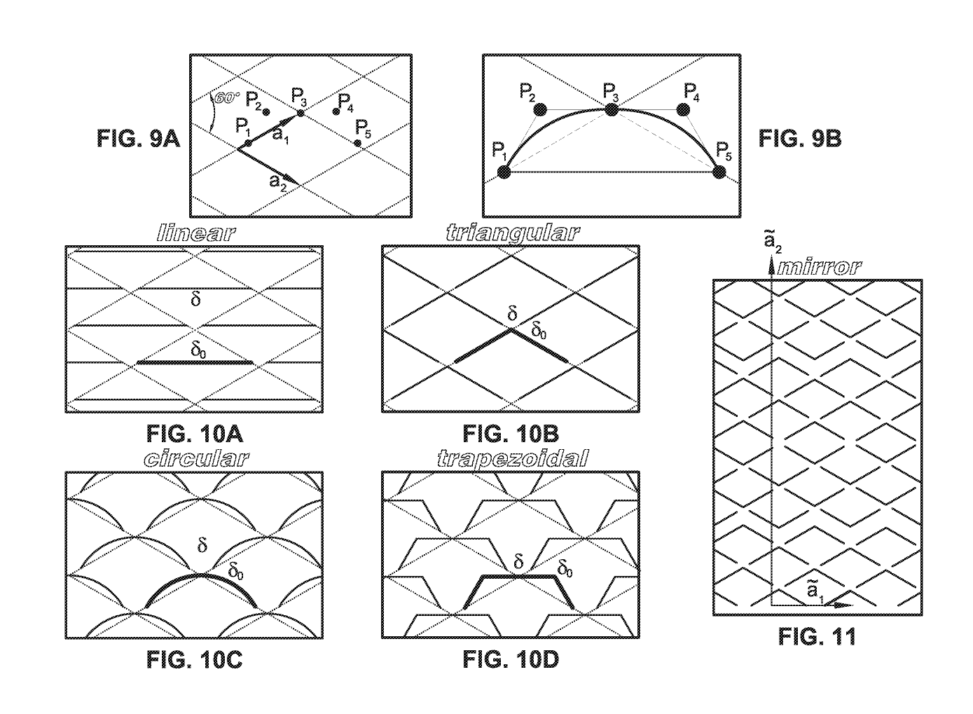

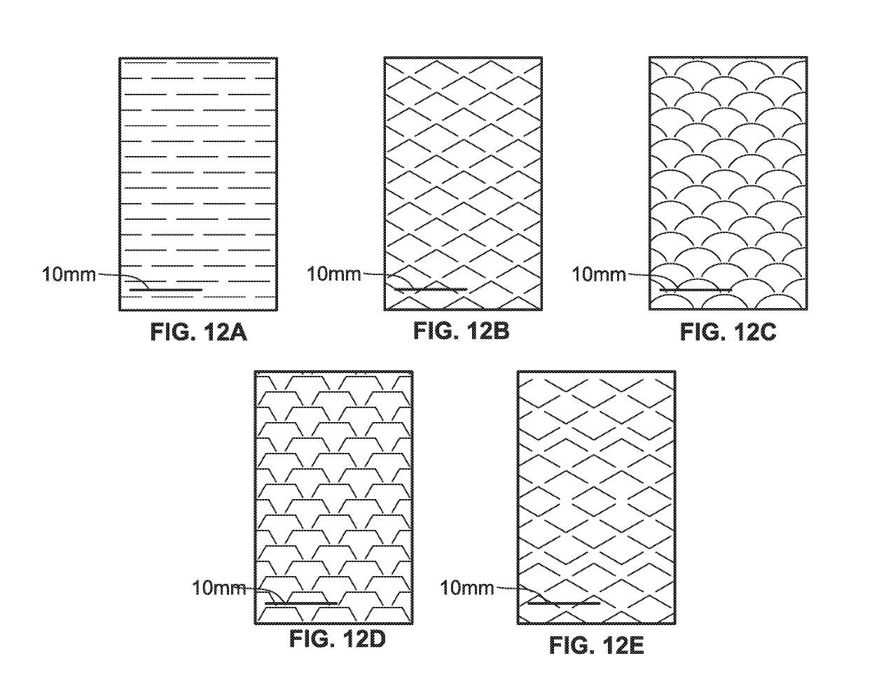

Referring to FIGS. 9A-12E, exemplary buckling-induced kirigami patterns are illustrated on a triangular grid. FIGS. 9A and 9B show unit cell and points used to generate different cut shapes. FIGS. 10A-10D show four different variants of cut shapes in the triangular grid, e.g., linear cuts in FIG. 10A, triangular cuts in FIG. 10B, circular cuts in FIG. 10C, and trapezoidal cuts in FIG. 10D. FIG. 11 illustrates a mirrored pattern based on triangular cuts. In FIGS. 10A-11, the repeating units are highlighted in each graph. FIGS. 12A-12E illustrate kirigami sheets that are fabricated via laser cutting of a polyester plastic sheet. The linear pattern pop-ups in both directions, while triangular, circular, and trapezoidal patterns pop-up in one direction. The pop-up of the triangular, circular, and trapezoidal patterns makes them suitable for attachment to a substrate or to curved surfaces.

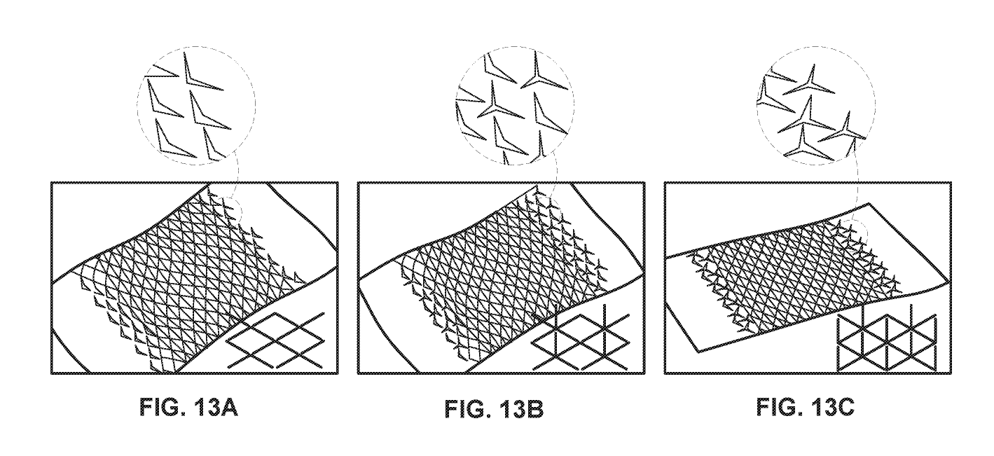

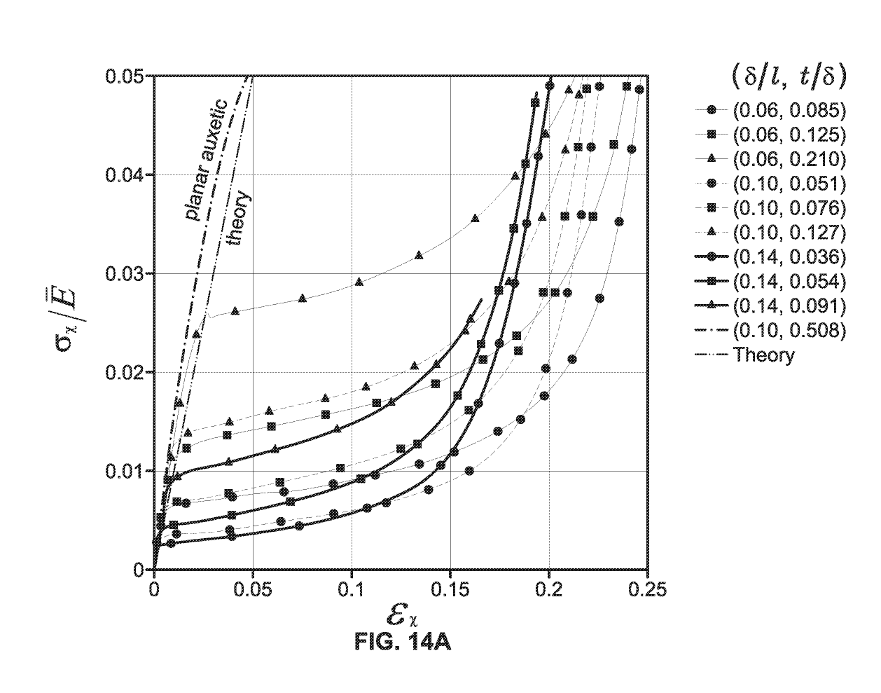

Referring generally to FIGS. 13A-13C, exemplary buckling-induced kirigami patterns are perforated on a triangular grid for tuning Poisson's ratio. In these patterns, the density of vertical lines controls the in-plane Poisson's ratio of the respective kirigami sheet. Specifically, FIG. 13A illustrates that a triangular pattern with no vertical line has the largest Poisson's ratio, FIG. 13B illustrates that cutting vertical lines in alternating columns reduces the Poisson's ratio, and FIG. 13C illustrates that having vertical lines on all columns results in a Poisson's ratio close to zero.

Referring to FIGS. 14A-14C, experimental results show the tensile response of perforate sheets. Specifically, FIG. 14A shows experimental stress-strain curves for perforated sheets characterized by different normalized hinge width δ/L and normalized sheet thickness t/δ for angle γ being 45°. The stress is normalized by the effective in-plane Young's modulus: Ē=⅔E(δ/l)². The experimental results show stress-strain responses for 10 samples characterized by different values of normalized thickness t/δ and normalized hinge width δ/l.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects. For example, the principles of the present disclosure are applicable to systems over a wide range of length scales and made of different materials because the properties of the presently-disclosed kirigami structures (which include, for example, designed kirigami skins) are primarily governed by the geometry of the respective structures, instead of being governed by constitutive ingredients of respective materials.

What is claimed is:

1. A kirigami structure, comprising:
a thin flat sheet; and
a square-shaped array of perforations cut in the sheet, the array including alternating rows and columns of adjacent orthogonal perforations interconnected via respective ligaments, the array forming
a two-dimensional planar surface in a load-free state, and
a three-dimensional kirigami surface in a tensile-load state in which a tensile load applied to the sheet causes out-of-plane buckling of the ligaments.

2. The kirigami structure of claim 1, wherein the perforations are square-shaped when they are fully opened under the tensile load.

3. The kirigami structure of claim 1, wherein the tensile load is applied in a perpendicular direction to edges of the array.

4. The kirigami structure of claim 3, wherein the three-dimensional kirigami surface is a cubic pattern in which the perforations have a narrow opening along the tensile load and a wide opening perpendicular to the tensile load.

5. The kirigami structure of claim 1, wherein the tensile load is applied in a diagonal direction to edges of the array.

6. The kirigami structure of claim 5, wherein the three-dimensional kirigami surface is a zigzag pattern in which the perforations have an equal opening for all the perforations.

7. The kirigami structure of claim 1, wherein the three-dimensional kirigami surface includes a periodic distribution of cuts and permanent folds.

8. The kirigami structure of claim 1, wherein the sheet has a flat configuration in which the sheet is laterally folded.

9. The kirigami structure of claim 1, wherein three-dimensional kirigami surface includes three stress states:
an initial linear state for small strain,
a stress plateau state during opening of the perforations, and
a final stiffening state when all the perforations are fully opened.

10. The kirigami structure of claim 1, wherein the sheet has a thickness of approximately 127 microns.

11. The kirigami structure of claim 10, wherein the sheet supports a weight of approximately 20 grams.

12. The kirigami structure of claim 1, wherein the array includes repeating identical units.

13. The kirigami structure of claim 1, wherein the sheet consists of a polyester plastic material.

14. The kirigami structure of claim 1, wherein the perforations are triangular-shaped when they are fully opened under the tensile load.

15. A kirigami structure, comprising:
a thin flat sheet having a square shape defined by sheet edges having a length 2L and a thickness t, the sheet having a flat configuration in a load-free state in which the sheet is laterally folded; and
a square-shaped array of perforations cut in the sheet, the array including alternating rows and columns of adjacent orthogonal perforations interconnected via respective ligaments, the array forming
an identical square unit of the sheet having a length l along each unit edge, the unit further including a hinge with a width δ along each unit edge,
a two-dimensional planar surface in the load-free state in which each of the perforations is closed, and
a three-dimensional kirigami surface in a tensile-load state in which a tensile load applied to the sheet causes out-of-plane buckling of the ligaments, each of the perforations being open in the tensile-load state.

16. The kirigami structure of claim 15, wherein the tensile load is applied at either a 0° angle or at a 90° angle relative to at least one of the sheet edges.

17. The kirigami structure of claim 15, wherein the tensile load is applied at a 45° angle relative to at least one of the sheet edges.

18. A method for transforming a sheet into a kirigami structure, the method comprising:
forming a square-shaped array of perforations that are cut into a thin flat sheet, the array including alternating rows and columns of adjacent orthogonal perforations interconnected via respective ligaments; and
in response to applying a tensile load to the sheet, causing out-of-plane buckling of the ligaments to change the array from a two-dimensional planar surface to a three-dimensional kirigami surface.

19. The method of claim 18, further comprising applying the tensile load in a perpendicular direction to edges of the array.

20. The method of claim 18, further comprising applying the tensile load in a diagonal direction to edges of the array.
